(19) United States
(12) Patent Application Publication
(10) Pub. No.: US 2025/0182511 A1
(43) Pub. Date: Jun. 5, 2025

(54) DOCUMENT ROTATION DETECTION AND CORRECTION

(71) Applicant: Intuit, Inc., Mountain View, CA (US)

(72) Inventors: Tharathorn RIMCHALA, San Francisco, CA (US); Xiangru LI, San Bruno, CA (US); Shir Meir LADOR, Mountain View, CA (US)

(21) Appl. No.: 18/525,501

(22) Filed: Nov. 30, 2023

(51) Int. Cl. G06V 30/146; G06V 30/148; G06V 30/19; G06V 30/40

(52) U.S. Cl. CPC G06V 30/1463; G06V 30/153; G06V 30/19147; G06V 30/1916; G06V 30/19173; G06V 30/40

(57) ABSTRACT

Certain aspects of the disclosure provide a method for generating training data and training a machine learning model. The method may include rotating each document image in a first set of document images by a plurality of rotation angles to obtain a first set of rotated document images and associating a rotation classification label to each rotated document image in the first set of rotated document images. The method may further include for each document image in a second set of document images: rotating the respective document image by a plurality of rotation angles, performing an optical character recognition analysis at each rotation angle of the plurality of rotation angles, generating a confidence score based on the optical character recognition analyses, assigning the confidence score to the respective document image, and associating a rotation classification to the respective document image based on the optical character recognition analyses.

### BACKGROUND

### Field

Aspects of the present disclosure relate to generating training data and training a document orientation correction system.

### Description of Related Art

In automated document processing systems, the orientation of input document images can have a significant impact on the performance of machine learning models used for analysis tasks like classification, optical character recognition (OCR), and information extraction. Many real-world documents are scanned or uploaded at arbitrary orientations that do not match the expected upright layout. For example, tax forms and other financial documents are frequently provided at orientations rotated 90, 180, or 270 degrees from the upright orientation.

Processing rotated document images using models trained on uniformly upright documents can negatively impact results. Rotated images contain text and content flowing in the wrong direction. OCR engines and other text analysis tools perform poorly on non-upright documents. Different rotations of the same document image can produce varying representations during image analysis. Overall, arbitrary orientations degrade model accuracy and training efficiency in document image understanding pipelines.

However, gathering labeled training data identifying document rotation is challenging. Large volumes of real-world document images lack explicit rotation angle ground truth labels. While limited manual labeling is feasible, it does not produce the class balanced training data needed for robust classification across all angles; and therefore, without ground truth labels, techniques, such as resampling, cannot be used to balance the training data. Synthetic data alone risks being misrepresentative of true rotation angle distributions in documents in production traffic. Current systems also lack automated mechanisms to detect and correct document rotation within processing workflows.

Therefore, there is a need for improved techniques of generating training data and models to identify document image rotation angles accurately and efficiently, without requiring large sets of manually labeled real-world data. Automatically detecting and correcting rotation would enable consistent upstream processing of document images in the proper orientation, maximizing downstream model performance on analysis tasks.

### SUMMARY

Certain aspects provide a method for training a machine learning model for document rotation detection. The method may include rotating each document image in a first set of document images by a plurality of rotation angles to obtain a first set of rotated document images, wherein each document image in the first set of document images has a known orientation and associating a rotation classification label to each rotated document image in the first set of rotated document images. For each document image in a second set of document images, the method includes rotating the respective document image by a plurality of rotation angles, performing an optical character recognition analysis at each rotation angle of the plurality of rotation angles, generating a confidence score based on the optical character recognition analyses, assigning the confidence score to the respective document image, and associating a rotation classification to the respective document image based on the optical character recognition analyses. The method may further include training a machine learning model to detect document rotation based on a combination of the first set of rotated document images having the associated rotation classifications and the second set of document images having the confidence scores and the associated rotation classifications.

Certain aspects provide a method for correcting a rotated document. The method may include providing a document image to a machine learning model trained on training data including: a first set of rotated document images, each rotated document image of the first set of rotated document images being associated with a known orientation label, and a second set of document images associated with an estimated orientation label and assigned an uncertainty weighting label based on an optical character recognition process, wherein the optical character recognition process is performed on a rotated version of each document in the second set of document images; predicting a document rotation angle for the provided document image; and rotating the provided document image to a known rotation angle based on the predicted document rotation angle.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts details of a document orientation correction system in accordance with examples of the present disclosure.

FIG. 2 depicts details of a system for generating training data with strong and weak labels for training a rotation classification model in accordance with examples of the present disclosure.

FIGS. 3A-3B depict examples of training data generation pipelines for generating weak labels in accordance with examples of the present disclosure.

FIG. 4 depicts an example of a training data generation pipeline for generating strong labels in accordance with examples of the present disclosure.

FIG. 5 depicts an example data structure in accordance with examples of the present disclosure.

FIG. 6 depicts an example method for generating training data and training a document orientation correction system in accordance with examples of the present disclosure.

FIG. 7 depicts an example method for correcting a rotated document in accordance with examples of the present disclosure.

FIG. 8 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training a document orientation correction system.

Scanned and uploaded document images are often provided in arbitrary, inconsistent orientations that do not match an expected upright or intended layout. Processing these randomly rotated documents using models trained on uniformly upright or intended images degrades the accuracy of downstream tasks like OCR, classification, and information extraction. Manually correcting document rotation is time-consuming and labor-intensive. Accordingly, there is a need for an automated technique to detect and standardize document orientation to increase the performance of document analysis tasks.

Empirical observations derived from the analysis of a vast dataset of production documents reveal that a significant majority of documents exhibit orientations that are a multiple of 90 degrees (0/90/180/270 rotations). Thus, rather than treating the problem of correcting document orientations as a 360-degree regression, which is common in the context of natural image rotation correction, the proposed techniques frame the problem as a four-class classification model. The four classes correspond to the following document orientations: 0 degrees, 90 degrees, 180 degrees, and 270 degrees.

This distinct problem framing offers several advantages over traditional approaches including, but not limited to enhanced accuracy, increased computational efficiency, and reduced ambiguity. That is, by reducing the number of possible orientations from 360 degrees to 4 classes, the classification model can achieve higher accuracy in determining the correct orientation of a document. The four-class classification model is computationally efficient, enabling faster document orientation detection and correction. Traditional 360-degree regression may result in ambiguous corrections when the angle of rotation is close to multiple possible orientations. The four-class classification model provides unambiguous corrections. In some examples, off 90 degree rotation (e.g., rotation angles other than multiple of 90 degrees) can be corrected to one of the 90 degrees rotation angles utilizing solutions such as a deskewing process, which may involve detecting a skew angle and rotating an image based on the detected skew angle. Thus, the techniques presented herein encompass the use of machine learning algorithms, neural networks, or any suitable computational techniques for training and implementing a four-class classification model to detect and correct document orientations accurately.

In accordance with examples of the present disclosure, techniques described herein involve training a machine learning model to accurately and confidently classify document rotation angles using a mix of real-world and synthetically generated training data. Real-world, or production, documents with uncertain, or weak, labels based on OCR analysis are combined with artificial documents that are rotated through multiple angles and assigned strong rotation, or orientation, labels. The diverse training data improves model generalization capabilities such that the trained model can automatically detect and correct the rotation of incoming documents to align them to an expected upright, or intended, orientation. Correcting documents to the upright or intended orientation allows consistent processing of downstream understanding models to increase accuracy and effectiveness.

In examples, techniques described herein are directed to generating training data and training machine learning models to detect and correct document image rotations. Such techniques provide a technical solution to the problem of inaccurate document analysis caused by misaligned images. The use of synthetic training data generation combined with uncertainty-based learning enables optimized model development without reliance on large labeled datasets. This improves upon existing manual labeling approaches that are resource-intensive. Further, the integration of OCR confidence scores enables weakly supervised training capabilities that are not restricted by human data gathering limits. The techniques therefore advance the field of document analysis by enabling automated learning of rotation detection models adapted to real-world distributions.

Further, the dynamic synthesis of artificially rotated documents and incorporation of uncertainty as described herein outperforms conventional predefined training sets. The ability to generate synthetic training images and assign estimated labels based on OCR analysis provides a flexible technical training architecture. This allows models to be optimized in a manner aligned with downstream document understanding tasks. The techniques enable a customized technical solution tailored to a model's training needs versus being limited by human-labeled datasets.

At least one benefit provided by the techniques for training machine learning models to detect and correct document rotation is improved accuracy in downstream document analysis tasks. By automatically rotating misaligned images to their proper upright orientations, OCR, classification, and information extraction models can operate on uniformly aligned documents as intended during training. This avoids degraded model performance caused by processing arbitrarily rotated images, enhancing document understanding performance. This streamlines operations and optimizes the use of human resources. Overall, the techniques offer multiple technical advantages in accuracy, automation, and flexibility for document rotation correction in real-world applications.

### Example System for Generating Training Data and Training a Document Orientation Correction System

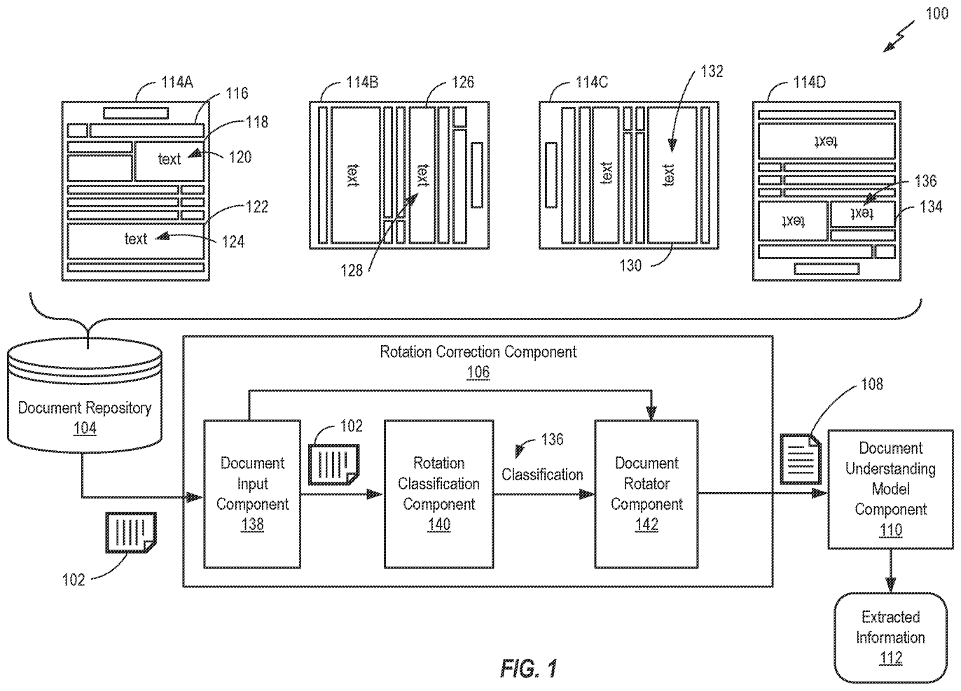

FIG. 1 depicts an example document orientation correction system 100 according to examples of the present disclosure. An input document image 102 representing a scanned or uploaded document image is received for processing. The input document image 102 may initially be in an unknown orientation. For example, the input document image 102 may be rotated 180 degrees from an expected orientation, where the expected orientation can be an orientation which is best suited for subsequent processing methods. In some examples, the document is provided, or retrieved, from a document repository 104 containing images, or images of documents, to be processed by the document orientation correction system 100. In accordance with some examples, a rotation correction component 106 processes the input document image 102 to determine its current orientation. The rotation correction component 106 generates a corrected output document image 108 rotated to a known upright, or expected, orientation for further processing. In some examples, a known upright, or expected, orientation may be an orientation where text or images are placed in the portrait orientation. When in the portrait orientation, the output document image 108 is in vertical alignment, where the height is greater than the width. In some examples, a known horizontal, or expected, orientation may be an orientation where text or images are set in the landscape orientation. When in the landscape orientation, the output document image 108 is in horizontal alignment, where the width is greater than the height. In some examples, the input document image 102 can be a square document having equal width and equal height; in such an example, the known upright, or expected, orientation is based on the orientation of the text without reference to an external document dimension.

In some examples, the corrected document image 108 is provided to a document understanding model component 110, which represents one or more models configured to perform a document analysis or processing task. For example, the one or more models may include one or more machine learning models configured to perform document analysis tasks. Such tasks may include classification, optical character recognition, information extraction, etc. The document understanding model component 110 processes the corrected document image 108 and extracts useful information 112 about its contents. Since the rotation correction component 106 aligned the input document image 102 to its expected orientation, the document understanding model component 110 can extract information 112 more accurately than if it received the document image in an unexpected orientation. Therefore, the rotation correction component 106 ensures document images are oriented properly before feeding them to downstream understanding models. This improves overall system performance by enabling optimal processing of uniformly upright document images.

FIG. 1 further illustrates example document images provided at different orientations that the document orientation correction system 100 may receive as input document image 102. Document image 114A depicts an example document image in a first upright 0 degree orientation. This document image contains a first text portion 116 and a second text portion 118 which includes text 120. Document image 114A also includes a third text portion 122 and text 124 included in the third text portion 122. Document image 114B depicts another example document image in a second orientation, where the second orientation is rotated 90 degrees clockwise from the first orientation. Due to the rotation, the first text portion 126 rotated according to the second orientation is oriented improperly in a horizontal fashion. Similarly, the rotated text 128 included in the first text portion 126 rotated according to the second orientation is oriented improperly in a horizontal fashion. Document image 114C depicts another example document image in a third orientation, where the third orientation is rotated 270 degrees clockwise from the first orientation. Due to the rotation, the first text portion 130 rotated according to the third orientation is oriented improperly. Similarly, the rotated text 132 included in the first text portion 130 rotated according to the third orientation is oriented improperly. In some examples, document image 114C depicts an example document image in a third orientation, where the third orientation is rotated −90 degrees clockwise (e.g., 90 degrees counterclockwise) from the first orientation. Document image 114D depicts another example document image in a fourth orientation, where the fourth orientation is rotated 180 degrees clockwise/counterclockwise from the first orientation. Due to the rotation, the first text portion 134 rotated according to the fourth orientation is oriented improperly and is considered upside-down. Similarly, the rotated text 136 included in the first text portion 134 rotated according to the fourth orientation is oriented improperly and is considered upside-down. These examples demonstrate how real-world document images provided as input document image 102 to the document orientation correction system 100 may be in arbitrary orientations that do not match the expected upright layout for optimal information extraction. The rotation correction component 106 addresses this by detecting the incoming document image's 102 orientation and rotating it to the proper upright alignment before further processing.

The rotation correction component 106 includes several sub-components to perform rotation detection and correction. A document input component 138 receives the input document image 102 from the document repository 104. The input document image may be in an arbitrary unknown orientation. A rotation classification component 140 analyzes the input document image 102 and predicts its current rotation angle. In one example, the rotation classification component 140 classifies the rotation into one of four orientations: 0, 90, 180, or 270 degrees. In some examples, the rotation classification component 140 is a machine learning model trained on training data from a plurality of document images. The rotation classification component 140 may include, but is not limited to, a neural network model such as a convolutional neural network, a transformer network, or other type of neural network. A document rotator component 142 takes the predicted rotation angle from the rotation classification component 140 and applies the inverse rotation to the document image to orient it in the proper 0 degree upright direction. For example, a document image classified as rotated 90 degrees counter-clockwise would be rotated by 90 degrees clockwise by the document rotator component 142. Therefore, by classifying the incoming document image's rotation and inverting the predicted rotation angle, the rotation classification components 140 and the document rotator component 142 work together to generate a uniformly upright document image 108 for further processing by downstream document understanding model components 110. This improves overall workflow performance.

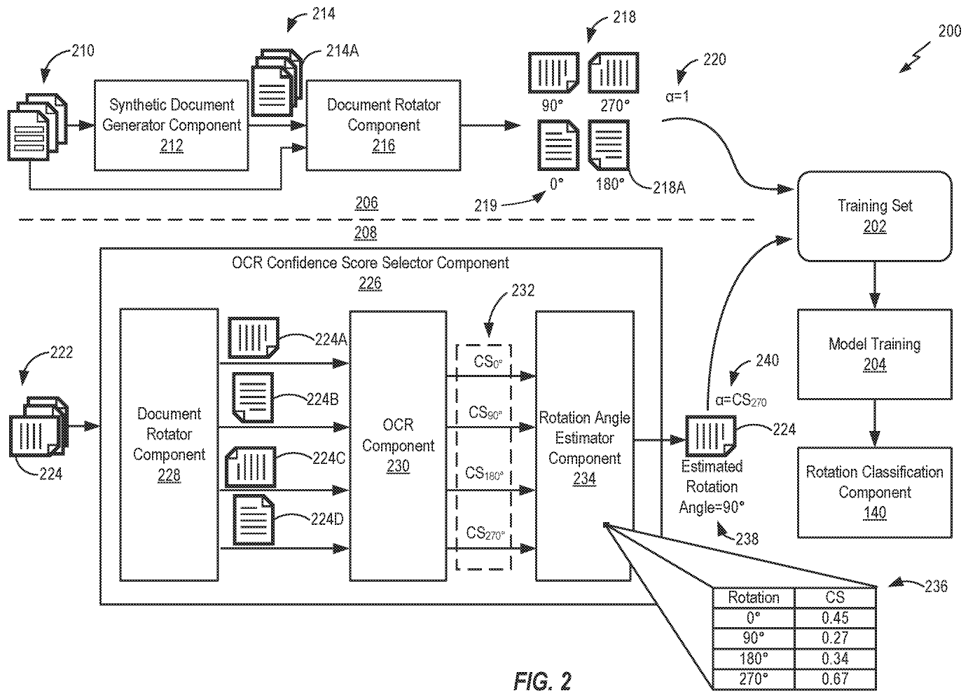

FIG. 2 illustrates a system 200 for generating training data to train the rotation classification component 140 in accordance with examples of the present disclosure. The system 200 utilizes a training set 202 containing document images with known orientations having weak and strong classification labels. A weak classification label is a type of label assigned to data instances in a classification problem with less reliable labels compared to a strong label. In traditional supervised learning, strong labels are considered to be ground truth labels that accurately and unambiguously represent the correct class or category of each data point. Weak labels, on the other hand, may be uncertain, noisy, or imprecise. A strong classification label, often simply referred to as a “label.” is a type of annotation or tag assigned to data instances in a classification problem. A distinction between weak and strong classification labels lies in their reliability and ambiguity. Strong labels are highly reliable and unambiguous, representing ground truth information, while weak labels are less reliable, often noisy or uncertain, and may come from various sources where obtaining strong labels is difficult. Model training 204 is performed using the training set 202 to produce the trained rotation classification component 140. The system 200 includes two pipelines for generating the training data. A first training data generation pipeline 206 creates training data based on a plurality of document images 210 having a known rotation. For illustrative purposes, the document images 210 having known rotations are forms utilized for tax filing. These tax-filing forms exhibit particular orientations, which are not arbitrary but are based on predetermined standards. For instance, these forms may be formatted in a manner conducive to efficient printing, distribution, manual reviewing, and mechanized scanning processes. In examples, the tax-filing forms are blank, meaning user-specific information is lacking from within the form. Other examples of document images 210 with known rotations include: medical records and medical forms, educational and examination papers, legal documents (e.g., contracts, deeds, etc.), and known business reports and filings (e.g., 10-K, 10-Q, 8-K, proxy statements, etc.). In some instances, the document images 210 with known rotations can be from public or open source repositories.

In some examples, the document images 210 having known rotations and lacking user-specific data (e.g., blank) are input into a synthetic document generator component 212. The synthetic document generator component 212 generates synthetic document images 214, including example document image 218A, based on the document images 210, where a synthetic document image refers to an image of a standard document that, while traditionally presented with blank fields awaiting user input, now contains text that has been synthetically generated. This synthetic text mimics or represents the kind of content a user would typically enter, offering a facsimile of a naturally filled-out form, even though the entries are artificially produced.

In an example, synthetic document images 214 are generated by populating empty form templates with artificial or sampled data. For example, a blank tax form can be filled with fake taxpayer information like names, addresses, incomes, etc. This data can be randomly generated or synthesized using generative models. Another approach involves compositing document fragments to create new combinations. Text patches, tables, graphs, logos and other elements from real documents are extracted. They are then overlaid on different backgrounds and compositions following predefined templates or random layouts. The contents can also be manipulated. For instance, font styles, colors, sizes, etc. can be changed. Realistic noise like speckles, lines, warping, and distortion can be applied. Watermarks and backgrounds may be added or removed.

The synthetic document generator component 212 creates synthetic document images 214 to expand the training data set for improved training set diversity. By generating synthetic document images 214, larger training sets with more variability can be obtained. This improves model robustness. The types of manipulations and compositions can be customized based on the target document's types being analyzed. For example, tax forms require different handling compared to receipts or invoices. Thus, training data covering the breadth needed for real-world generalization can be generated utilizing the synthetic document generator component 212.

The synthetic document images 214 are provided to a document rotator component 216, which rotates a synthetic document image through multiple angles such as 0, 90, 180 and 270 degrees. The document rotator component 216 performs controlled rotations of document images to generate the rotated training document images 218. The document rotator component 216 receives document images such as synthetic document images 214, document images 210 having known rotations, or combinations thereof, as input. For each input document image, the document rotator component 216 programmatically rotates the image (e.g., in a clockwise direction) by specified angles such as 90, 180, and 270 degrees. This produces additional document versions at different orientations. The rotation operation digitally manipulates the pixel values of the image matrix to effectively turn the document image by the specified angle. In examples, the rotation operation can utilize matrix multiplication to turn the document image by the specified angle. The document rotator component 216 rotates document images in precise degree increments. For example, a 90 degree rotation turns the document image exactly 90 degrees clockwise on its axis. This allows each output document image 218 to have a known degree of rotation relative to the original orientation.

Each rotated document image (e.g., 218A) of the rotated training document images can be associated with or assigned a strong label 219 (e.g., 0, 90, 180, 270 degrees). The rotated output document images 218 are then provided and/or combined with other training data in training set 202. In some examples, an uncertainty weighting 220 for model training is associated with each rotated version 218; since the original orientation of synthetic document images 214 is known, the uncertainty weighting 220 can have a weighting equal to the maximum weight (e.g., upper bound). The uncertainty weighting 220 in the first training data generation pipeline 206 represents strong label values that can be leveraged during model training 204. By systematically rotating document images, the document rotator component 216 generates balanced datasets covering multiple orientations which expands the training data available to train the model to classify rotation angles.

The second training data generation pipeline 208 utilizes a set of production document images 222. In contrast to the first training data generation pipeline 206, the production document images 222 do not have known rotation angle labels and have no rotation ground truths. In examples, a production document image 224 can be a user-provided document. For example, production document images 224 may be a document that a user has filled out or otherwise provided user information, scanned or photographed the document, and uploaded the document. Texts and digits in document images help models differentiate between upright and upside-down orientations. To improve this differentiation, a training dataset with weak labels is created and leveraged to perform model training. The production document images 222 without specified rotations are provided to an optical character recognition (OCR) confidence score selector component 226 whereby the production document images 222 are rotated in 90-degree increments and processed using OCR. Based on the OCR's confidence, an estimated rotation angle can be assigned to the production document image. In some examples, a label confidence based on the OCR's confidence can also be attached to the estimated rotation angle.

Each production document image 224 is provided to a document rotator component 228. The document rotator component 228 performs controlled rotations of document images through multiple angles to generate rotated versions. For each input document image, the document rotator component 228 programmatically rotates the image (e.g., in a clockwise direction) by specified angles such as 90, 180, and 270 degrees. This produces additional document image versions 224A-224D at different rotations or orientations. The rotation operation digitally manipulates the pixel values of the image matrix to effectively turn the document image by the specified angle. Various interpolation techniques, such as bilinear or bicubic sampling, are used to determine the transformed pixel values after rotation. The document rotator component 228 rotates document images in precise degree increments. For example, a 90 degree rotation turns the document image exactly 90 degrees clockwise around the centroid. This allows each output document image 218 to have a known degree of rotation relative to the original orientation.

The rotated versions 224A-224D are input to an OCR component 230, which performs OCR analysis on each version 224A-224D and outputs confidence scores 232 indicating the OCR quality for each rotated document image version. The OCR component 230 analyzes document images to detect and extract textual content using machine learning-based techniques. The OCR component 230 applies OCR techniques to identify text areas within the document images, segment the text into characters, and recognize the textual content. In some examples, the OCR component 230 performs feature extraction to understand shapes and patterns, as well as classification to distinguish and recognize characters.

A confidence score 232 indicating how certain the OCR component 230 is about its recognition results is also obtained. The confidence score can be calculated using a variety of methods. For example, the OCR component 230 can produce a probability distribution over possible characters for each position in the input document image, where the highest probability can be used as a measure of confidence at the individual character level. As another example, the OCR component 230 may employ a feature matching process which involves comparing extracted features from scanned characters against predefined templates or patterns to recognize and classify the characters. The confidence scores 232 are quantifications of this character level confidence aggregated to the document level to generate confidence scores at each document image orientation.

Higher OCR confidence scores indicate the OCR component 230 was able to extract and recognize a greater proportion of text from the document image correctly. Lower scores indicate that a higher proportion of text regions were localized with lower confidence and/or higher proportion of characters inside the detected text regions classified with lower character recognition confidence. The rotation angle estimator component 234 analyzes the relative OCR confidence scores 232 from the OCR component 230 to estimate the most likely original orientation of production document images 222. For example, for each production document image 224A-D, the rotation angle estimator component 234 considers the set of OCR confidence scores 232 obtained at different rotation angles such as 0, 90, 180 and 270 degrees. The rotation angle estimator component 234 compares the scores to identify the maximum, or highest, value. The angle of rotation that yielded the highest OCR confidence score is likely the original upright or expected orientation of that document image, as text in its original orientation generally results in the best OCR quality.

Table 236 shows confidence scores 232 for an example production document image 224 rotated through four angles. The highest score of 0.67 occurs at 270 degrees, indicating the original document image was likely oriented at 90 degrees (e.g., 360 degrees−270 degrees=90 degrees). For example, if a production document image 224 has OCR confidence scores of 0.45, 0.27, 0.34 and 0.67 for rotation angles of 0, 90, 180 and 270 degrees, respectively, then the rotation angle estimator component 234 would determine the maximum confidence of 0.67 occurred at 270 degrees. Therefore, the estimated rotation angle label 238 for this production document image 224 would be set to 90 degrees (e.g., 360 degrees−270 degrees=90 degrees), indicating the original likely orientation. This estimated rotation angle has an uncertainty based on the OCR score analysis specific to the confidence score yielding the highest, or maximum value. Accordingly, the confidence score may be equal to 0.67 in this example. The original input production document image 224 can be associated with or otherwise assigned an estimated rotation angle label 238 equal to 90 degrees; further, the original input production document image 224 can be associated with or otherwise assigned an uncertainty weighting 240 for model training that is equal to the confidence score CS₂₇₀.

By leveraging OCR as a signal for text orientation, the OCR confidence score selector component 226 can automatically generate estimated rotation labels on production document images 222 lacking ground truth. This creates large scale uncertain (weakly labeled) training data to supplement the strongly labeled rotated document images 218. That is, the estimated rotation angle label 238 having uncertainty weightings 240 are combined with the strong labels 219 from the first training data generation pipeline 206 during model training 204. By leveraging uncertain real-world data, pipeline 208 improves generalization of the rotation detection model beyond the scale of small strongly labeled datasets. In examples, the model training 204 includes training the model using a combination of the first set of rotated document images 218 and a second set of document images 222 by iteratively determining a loss using an uncertainty-aware loss function that weights loss terms based on magnitudes of the confidence scores. In examples, the modeling training occurs by minimizing the uncertain aware loss function over k to K classes according to:

$$L ( y , \hat{y} \vert α ) = {\sum }_{k}^{K} α * {y}^{( k )} * log {\hat{y}}^{( k )}$$

where y is the ground truth encoded label, ŷ is the predicted probability distribution over k classes, and a is the uncertainty weight. The weight can be equal to 1 for all data points with known rotation labels (e.g., first training data generation pipeline 206), and between 0 and 1 for all data points for which the labels are derived from OCR feedback (e.g., second training data generation pipeline 208). Thus, the loss function weights the contribution of each training example by its label uncertainty a. This allows the model to rely primarily on data points with strong labels, while still utilizing the weak labels from OCR to improve model generalization.

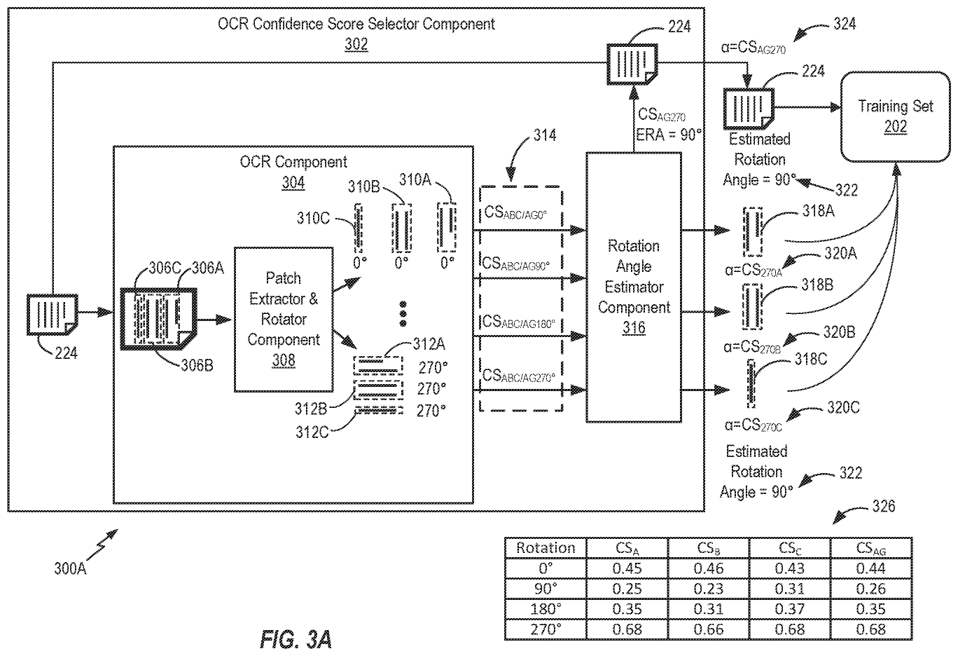

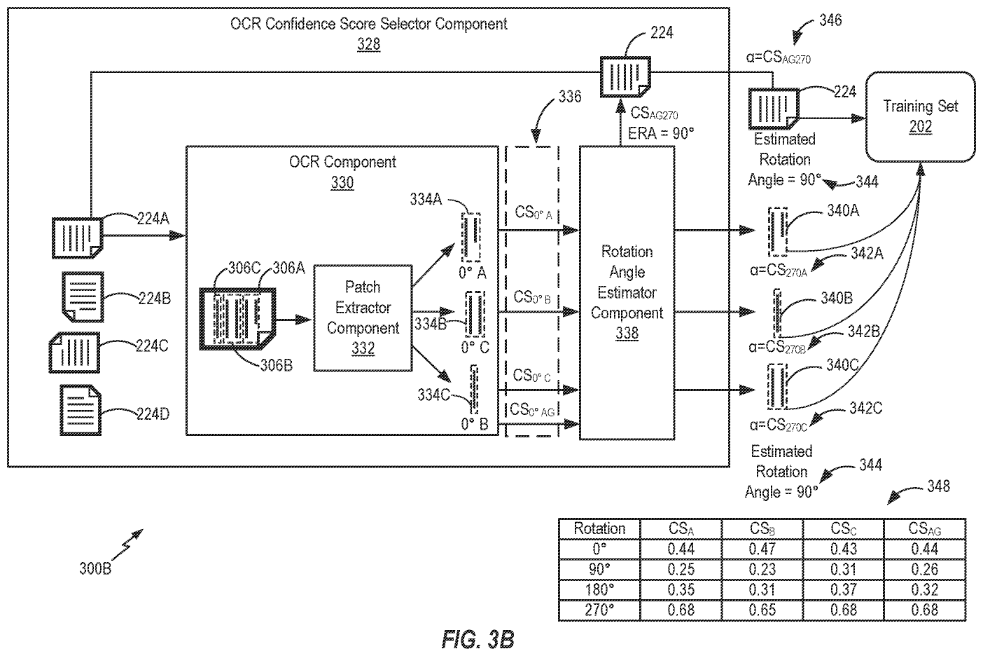

FIG. 3A illustrates another example of a training data generation pipeline 300A in accordance with examples of the present disclosure. The training data generation pipeline 300A utilizes an OCR confidence score selector component 302 to estimate rotation angles of production document images 224 based on patches of text contained within the production document images 224. In some examples, the training data generation pipeline 300A utilizes an OCR confidence score selector component 302 to estimate rotation angles of patches of text within production document images 224 and provide the patches of text as training data to the training set 202. By analyzing text patches in localized regions, the original document image orientation of a production document image 224 can be estimated more confidently.

Similar to the second training data generation pipeline 208 (FIG. 2), a production document image 224 is received at an OCR component 304. The production document image 224 may contain a first text portion 306A, a second text portion 306B, and a third text portion 306C. Accordingly, a patch extractor and rotator component 308 of the OCR component 304 extracts patch portions containing the text portions 306A-306C from the production document image 224. The patch extractor and rotator component 308 then rotates the patches through different angles such as 0, 90, 180 and 270 degrees. As an example, the patch extractor and rotator component 308 utilizes optical character recognition or other text detection techniques to identify the locations and boundaries of text blocks within the document image. The patch extractor and rotator component 308 then extracts image patches located around each detected text portion (e.g., 306A-306C). In some examples, the patch extractor and rotator component 308 extracts image patches centered around each detected text portion (e.g., 306A-306C). These patches contain the segmented text in its local document image context. The patch extractor and rotator component 308 then programmatically rotates the extracted patches through multiple angles. This results in patch versions representing the text segment at different orientations, such as the 0 degree and 270 degree versions shown. Patch portion 310A represents the first text portion 306A extracted and rotated to 0 degrees. Patch portion 310B represents the second text portion 306B rotated to 0 degrees. Patch portion 310C represents the third text portion 306C rotated to 0 degrees. Similarly, patch portions 312A. 312B, and 312C represent the extracted first, second, and third text portions respectively but now rotated to 270 degrees. By isolating text patches, the OCR process can focus on recognizing content within a smaller region. This provides finer-grained orientation signals compared to analyzing the full document image directly. In some examples, an amount of processing resources can also be reduced, as fewer image pixels may be processed. In some examples, by reducing an amount of required processing resources, the speed at which the training data generation pipeline 300A operates can be increased.

The OCR component 304 performs optical character recognition, using an OCR process as previously described, on the rotated patch portions (e.g., at 0, 90, 180 and 270 degree rotations) and outputs confidence scores 314 indicating the OCR quality for each patch at different orientations. A rotation angle estimator component 316 analyzes the OCR confidence scores 314 to identify the highest scoring orientation for each text patch. The angle of rotation that yielded the highest OCR confidence score is likely the original upright or expected orientation of that patch, as text in its original orientation generally results in the best OCR quality. The rotation angle estimator component 316 assigns or associates the original text patch (e.g., 306A. 306B, 306C) with an estimated rotation angle and the highest OCR confidence score. For example, patch 318A represents the first text portion 306A extracted in its original orientation from the production document image 224. The OCR confidence scores 314 indicate the 270 degree rotation of this patch yielded the highest confidence score 320A. Therefore, the original orientation of text portion 306A is estimated as 90 degrees (e.g., 360 degrees−270 degree=90 degrees). Similarly, confidence scores 320B and 320C indicate original orientations of 90 degrees for second text portion 306B and third text portion 3060 respectively based on their highest OCR scores corresponding to patch 318B and 318C respectively. By evaluating OCR results on localized document image regions at different alignments, the rotation angle estimator component 316 can estimate the initial document image rotation with patch-level granularity. This provides uncertain labels with higher accuracy.

As described above, the rotation angle estimator component 316 analyzes the OCR confidence scores 314 to identify the highest scoring orientation for each extracted text patch 310A-312C, indicating the most likely original upright alignment of that patch. Based on the analysis of all text patches extracted from the production document image 224, the rotation angle estimator component 316 generates an estimated rotation angle 322 for the overall production document image 224. This represents the uncertainty document-level label or weighting. For example, an aggregate confidence score is calculated based on the individual patch confidence scores to quantify the overall uncertainty 324 of the predicted label 322 or association for the production document image 224. As depicted in table 326, the patch-level confidence scores are aggregated, leading to a document rotation angle prediction of 90 degrees (e.g., 360 degrees-270 degrees=90 degrees) for the production document image 224, with an aggregate confidence score of 0.68. Thus, the uncertainty label 324 can be assigned or associated with the original production document image 224. The production document image 224 can be provided as training data to the training set 202 as previously described.

FIG. 3B illustrates another example of a training data generation pipeline 300B in accordance with examples of the present disclosure. The training data generation pipeline 300B utilizes an OCR confidence score selector component 328 to estimate rotation angles of production document images 224 based on patches of text contained within the production document images 224. In some examples, the training data generation pipeline 300B utilizes an OCR confidence score selector component 328 to estimate rotation angles of patches of text within production document images 224 and provide the patches of text as training data to the training set 202. By analyzing text patches in localized regions, the original document image orientation of a production document image 224 can be estimated more accurately.

Similar to the second training data generation pipeline 208 (FIG. 2), a rotated production document image 224 is received at an OCR component 330. In examples, additional document image versions 224A-224D corresponding to different rotations or orientations of production document image 224 are provided to the OCR component 330. The additional document image version 224A-224D may be provided from a document rotator component as previously described with respect to the document rotator component 228 (FIG. 2). The OCR component 330 utilizes a patch extractor component 332 to extract patch portions containing the text portions 306A-306C from the rotated version of the production document image 224 (e.g., 224A depicted in FIG. 3B). The patch extractor component 332 utilizes optical character recognition or other text detection techniques to identify the locations and boundaries of text blocks within the document image. The patch extractor component 332 then extracts image patches located around each detected text portion (e.g., 306A-306C). In some examples, the patch extractor component 332 extracts image patches centered around each detected text portion (e.g., 306A-306C). These patches contain the segmented text in its local document context. Patch portion 334A represents the first text portion 306A extracted from the production document image 224A. Patch portion 334B represents the second text portion 306B extracted from the production document image 224A. Patch portion 334C represents the third text portion 306C extracted from the production document image 224A. By isolating text patches, the OCR process can focus on recognizing content within a smaller region. This provides finer-grained orientation signals compared to analyzing the full document image directly. In some examples, an amount of processing resources can also be reduced, as fewer image pixels may be processed. In some examples, by reducing an amount of required processing resources, the speed at which the training data generation pipeline 300B operates can be increased.

The OCR component 330 then performs optical character recognition on the extracted text patches for each of the rotated production document images 224A-D (e.g., 224A rotated 0 degrees, 224B rotated 90 degrees, 224C rotated 180 degrees, 224D rotated 270 degrees). The OCR component 330 generates OCR confidence scores 336 indicating the confidence of the OCR process at each orientation for each patch. The rotation angle estimator component 338 analyzes the OCR confidence scores 336 from the extracted patches to determine the highest scoring orientation for each patch. This process estimates the likely original alignment of the text segment within the production document image 224.

As described above, the rotation angle estimator component 338 analyzes the OCR confidence scores 336 to identify the highest scoring orientation for each extracted text patch for each orientation, indicating the most likely original upright alignment of that patch. Based on the analysis of all text patches extracted from the rotated production document images 224A-D, the rotation angle estimator component 338 generates an estimated rotation angle 344 for the overall production document image 224. This represents the uncertainty document-level label or weighting. For example, an aggregate confidence score is calculated based on the individual patch (e.g., 340A-340C) confidence scores (e.g., 342A-342C) to quantify the overall uncertainty 346 of the predicted label 344 or association for the production document image 224. As depicted in table 348, the patch-level confidence scores are aggregated, leading to a document image rotation angle prediction of 90 degrees (e.g., 360 degrees−270 degrees=90 degrees) for the production document image 224, with an aggregate confidence score of 0.68. Thus, the uncertainty label 346 can be assigned or associated with the original production document image 224. The production document image 224 can be provided as training data to the training set 202 as previously described.

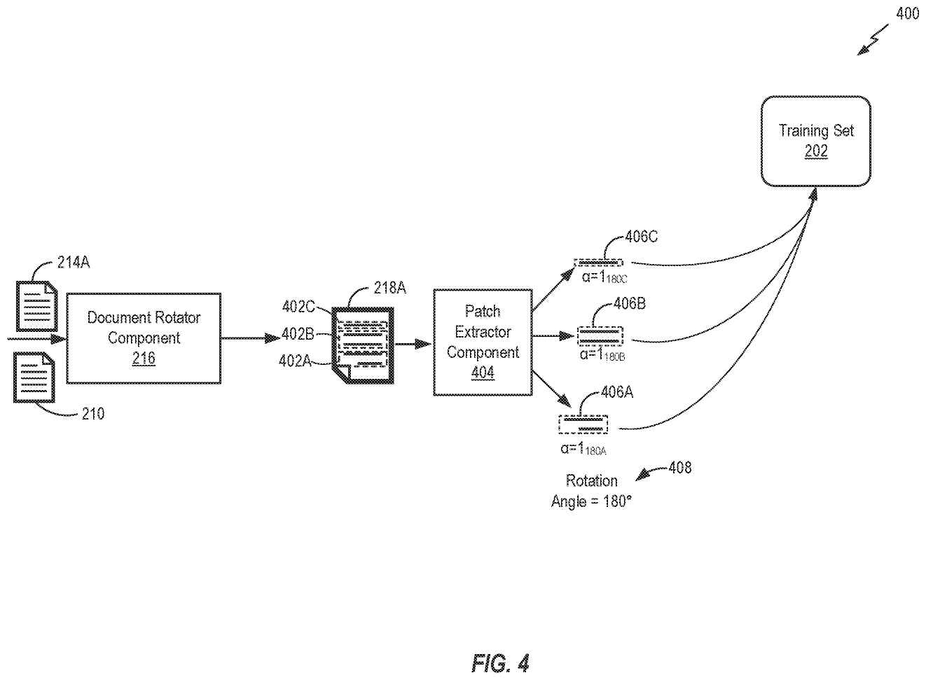

FIG. 4 illustrates another example of a training data generation pipeline 400 in accordance with examples of the present disclosure. The training data generation pipeline 400 generates training data based on patches of text contained within the plurality of document images 210 having a known rotation. In examples, the training data generation pipeline 400 operates on synthetic document images 214 and/or the plurality of document images 210 having a known rotation. The synthetic document images 214 and/or the document images 210 having a known rotation are provided to the document rotator component 216 which rotates them through multiple angles such as 0, 90, 180 and 270 degrees as previously described. The document rotator component 216 performs controlled rotations of document images to generate the rotated training document images 218. The rotated output document images 218 are then provided to a patch extractor component 404. The patch extractor component 404 extracts patch portions containing the text portions 402A-402C from the rotated version of the production document synthetic document image 214A or the document image 210. The patch extractor component 404 utilizes optical character recognition or other text detection techniques to identify the locations and boundaries of text blocks within the document image. The patch extractor component 404 then extracts image patches located around each detected text portion (e.g., 402A-402C). In some examples, the patch extractor component 404 extracts image patches centered around each detected text portion (e.g., 402A-402C). These patches contain the segmented text in its local document context. Patch portion 406A represents the first text portion 402A extracted from the document image 218A. Patch portion 406B represents the second text portion 406B extracted from the document image 218A. Patch portion 406C represents the third text portion 402C extracted from the document image 218A. By isolating text patches, the patches of text provided to the training set have known rotations 408. The extracted patches 406, having the known rotation 408, are added to the training dataset for the rotation classification component 140. By generating augmented examples through controlled rotation, strongly labeled data covering multiple orientations can be produced to improve model robustness.

### Example Data Structure for Storing Training Data

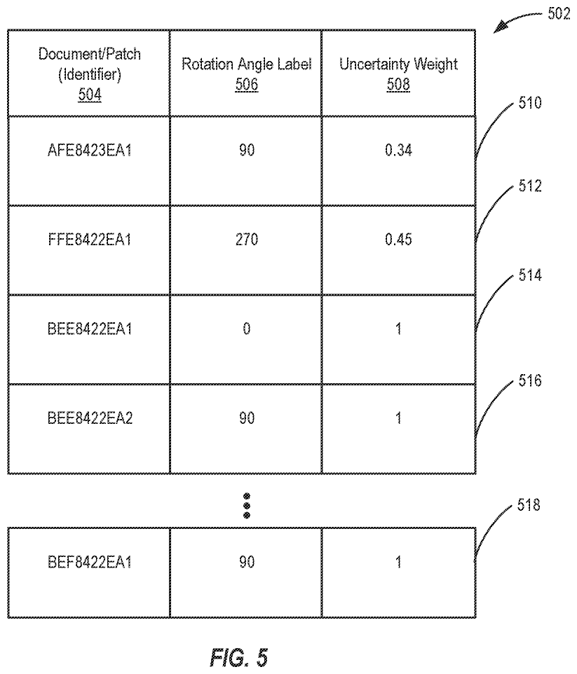

FIG. 5 illustrates an example data structure 502 for storing training data with uncertain labels and weights according to examples of the present disclosure. The data structure 502 contains rows storing information about individual training document image images or patches. Columns include a document image/patch identifier 504, a rotation angle label 506, and an uncertainty weight 508. For example, row 510 stores information for a document image with ID AFE8423EA1, a rotation angle label of 90 degrees, and an uncertainty weight of 0.34. Similarly, row 512 stores information for a document image with ID FFE8422EA1, a rotation angle label of 270 degrees, and an uncertainty weight of 0.45. Row 514 stores information for a document image with ID BEE8422EA1, a rotation angle label of 0 degrees, and an uncertainty weight of 1, indicating a high confidence for this strong label. Additional rows 516 and 518 represent information for further training document image images and patches with a mix of uncertain and strongly labeled data. This unified data structure 502 containing both generated and augmented training data provides an efficient representation for uncertainty-aware model training.

### Example Method of Training a Machine Learning Model for Document Image Rotation Detection

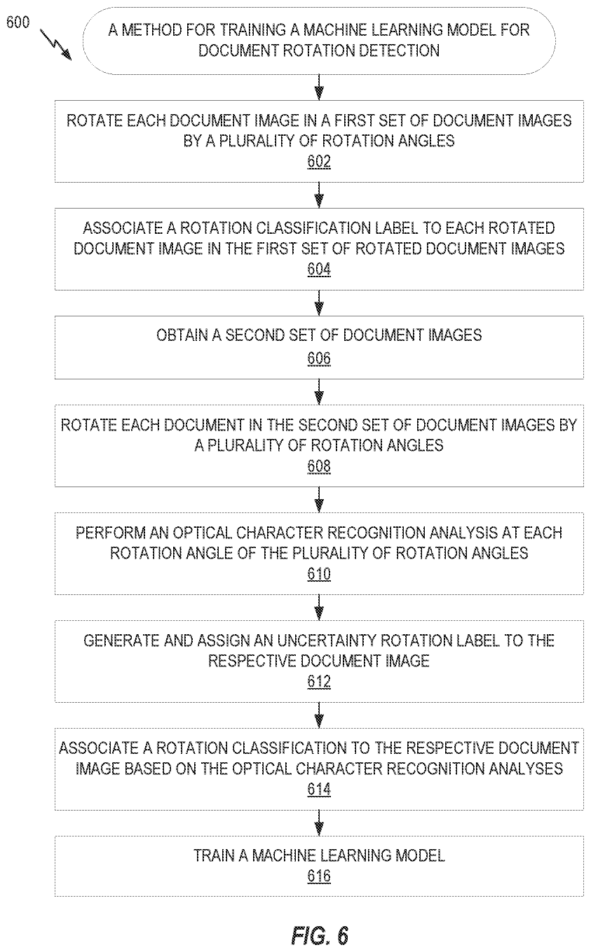

FIG. 6 depicts an example method of training a machine learning model for document image rotation detection. In one aspect, method 600 can be implemented by document orientation correction system 100 of FIG. 1. Method 600 starts at block 602 with rotating each document image in a first set of document images by a plurality of rotation angles to obtain a first set of rotated document images. In examples, each document image in the first set of document images has a known orientation. In accordance with some examples, the first set of document images are generated by adding text to one or more portions of an empty document field within a document image.

The method 600 continues to block 604 with associating a rotation classification label to each rotated document image in the first set of rotated document images. In accordance with some examples, the plurality of rotation angles comprise 0, 90, 180, and 270 degrees.

The method 600 continues to block 606 with obtaining a second set of document images. In examples, the second set of document images may be production document images 222.

The method 600 continues to block 608 with rotating each document in the second set of document images by a plurality of rotation angles.

The method 600 continues to block 610 with performing an optical performing an optical character recognition analysis at each rotation angle of the plurality of rotation angles.

The method 600 continues to block 612 with generating a confidence score based on the optical character recognition analyses and assigning the confidence score to the respective document image. In accordance with some examples, generating the confidence score is based on the optical character recognition analyses and includes recording an optical character recognition analysis confidence score at each rotation angle of the plurality of rotation angles; and comparing the optical character recognition analysis confidence scores for each rotation angle of the plurality of rotation angles to identify a highest confidence score, wherein the confidence score is the highest confidence score. In accordance with some examples, assigning the generated uncertain rotation label includes analyzing the document image using optical character recognition to detect one or more text regions, extracting one or more cropped image patches that include the detected one or more text regions from the document image, performing an optical character recognition process on the one or more extracted cropped image patches at different rotation angles, and assigning the generated confidence score based on the extracted one or more cropped image patches at different rotation angles.

The method 600 continues to block 614 with associating a rotation classification label to the respective document image based on the optical character recognition analyses.

The method 600 continues to block 616 with training a machine learning model to detect document rotation based on a combination of the first set of rotated document images having the associated rotation classification labels and the second set of document images having the confidence scores and the associated rotation classifications. In accordance with some examples, training the machine learning model on the combination of the first set of rotated document images and the second set of document images comprises iteratively determining a loss using an uncertainty-aware loss function that weights loss terms based on magnitudes of the confidence scores. In some examples, a confidence score is assigned to each document image in the first set of rotated document images.

In some examples, a document image is provided to the trained machine learning model to determine a document image rotation for the provided document and the provided document is rotated to a known rotation based on the determined document rotation.

Note that FIG. 6 is just one example of a method, and other methods including fewer, additional, or alternative steps are possible consistent with this disclosure.

### Example Method of Correcting a Rotated Document

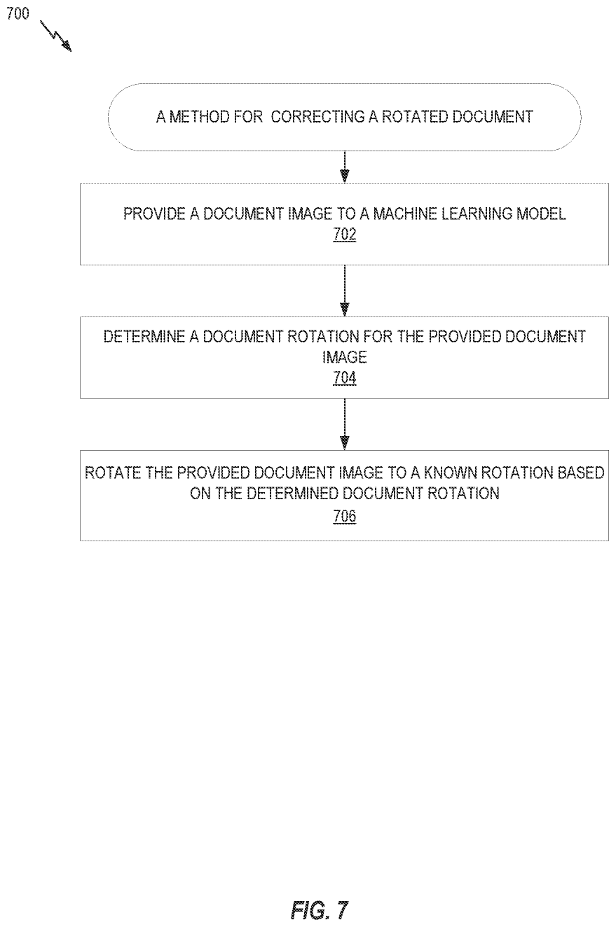

FIG. 7 depicts an example method of correcting a rotated document. In one aspect, method 700 can be implemented by document orientation correction system 100 of FIG. 1. Method 700 starts at block 702 with providing a document image to a machine learning model. In examples, the machine learning model is trained on training data including: a first set of rotated document images, each rotated document image of the first set of rotated document images being associated with a known orientation label, and a second set of document images associated with an estimated orientation label and assigned an uncertainty weighting label based on an optical character recognition process, wherein the optical character recognition process is performed on a rotated version of each document in the second set of document images. In examples, the optical character recognition process is performed on each document in the second set of document images at angles comprising 0, 90, 180, and 270 degrees.

The method 700 continues to block 704 with determining a document rotation for the provided document image.

The method 700 continues to block 706 with rotating the provided document image to a known rotation based on the determined document rotation.

Note that FIG. 7 is just one example of a method, and other methods including fewer, additional, or alternative steps are possible consistent with this disclosure.

### Example Processing System for Generating Training Data and Training a Document Orientation Correction System

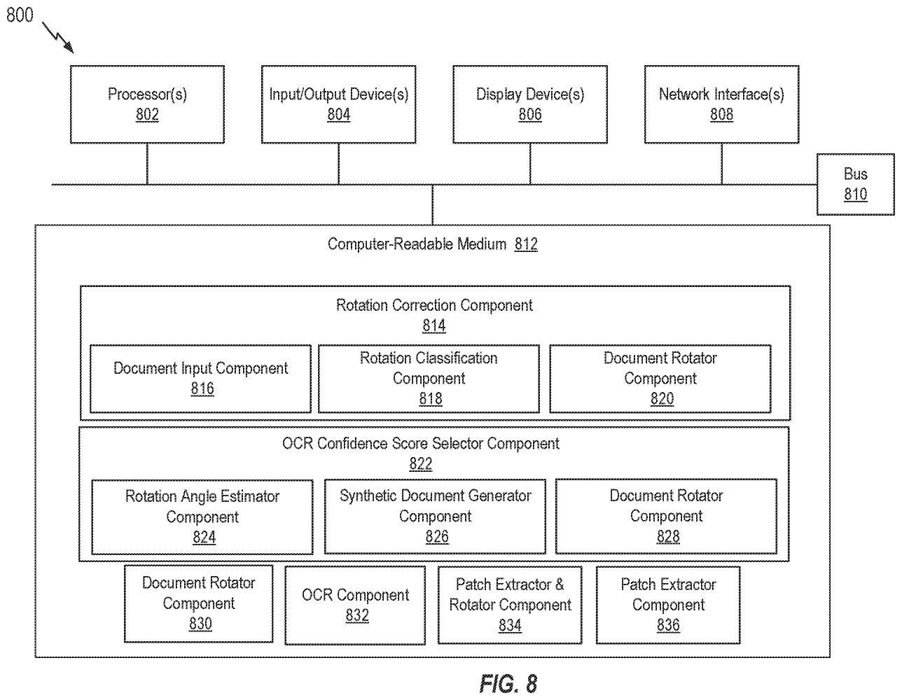

FIG. 8 depicts an example processing system 800 configured to perform various aspects described herein, including, for example, methods 600 and 700 as described above with respect to FIG. 6 and FIG. 7.

Processing system 800 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 800 includes one or more processors 802, one or more input/output devices 804, one or more display devices 806, one or more network interfaces 808 through which processing system 800 is connected to one or more networks (e.g., a local network, an intranet, the Internet, or any other group of processing systems communicatively connected to each other), and computer-readable medium 812. In the depicted example, the aforementioned components are coupled by a bus 810, which may generally be configured for data exchange amongst the components. Bus 810 may be representative of multiple buses, while only one is depicted for simplicity.

Processor(s) 802 are generally configured to retrieve and execute instructions stored in one or more memories, including local memories like computer-readable medium 812, as well as remote memories and data stores. Similarly, processor(s) 802 are configured to store application data residing in local memories like the computer-readable medium 812, as well as remote memories and data stores. More generally, bus 810 is configured to transmit programming instructions and application data among the processor(s) 802, display device(s) 806, network interface(s) 808, and/or computer-readable medium 812. In certain embodiments, processor(s) 802 are representative of a one or more central processing units (CPUs), graphics processing unit (GPUs), tensor processing unit (TPUs), accelerators, and other processing devices.

Input/output device(s) 804 may include any device, mechanism, system, interactive display, and/or various other hardware and software components for communicating information between processing system 800 and a user of processing system 800. For example, input/output device(s) 804 may include input hardware, such as a keyboard, touch screen, button, microphone, speaker, and/or other device for receiving inputs from the user and sending outputs to the user.

Display device(s) 806 may generally include any sort of device configured to display data, information, graphics, user interface elements, and the like to a user. For example, display device(s) 806 may include internal and external displays such as an internal display of a tablet computer or an external display for a server computer or a projector. Display device(s) 806 may further include displays for devices, such as augmented, virtual, and/or extended reality devices. In various embodiments, display device(s) 806 may be configured to display a graphical user interface.

Network interface(s) 808 provide processing system 800 with access to external networks and thereby to external processing systems. Network interface(s) 808 can generally be any hardware and/or software capable of transmitting and/or receiving data via a wired or wireless network connection. Accordingly, network interface(s) 808 can include a communication transceiver for sending and/or receiving any wired and/or wireless communication.

Computer-readable medium 812 may be a volatile memory, such as a random access memory (RAM), or a nonvolatile memory, such as nonvolatile random access memory (NVRAM), or the like. In this example, computer-readable medium 812 includes a rotation correction component 814, document input component 816, rotation classification component 818, document rotator component 820, OCR confidence score selector component 822, rotation angle estimator component 824, synthetic document generator component 826, document rotator component 828, document rotator component 830, OCR component 832, patch extractor and rotator component 834, and patch extractor component 836.

In certain embodiments, the rotation correction component 814 is configured to be the same as or similar to the rotation correction component 106. In certain embodiments, the rotation classification component 818 is configured to be the same as or similar to the document input component 138. In certain embodiments, the rotation classification component 818 is configured to be the same as or similar to the rotation classification component 140. In certain embodiments, the document rotator component 820 is configured to be the same as or similar to the document rotator component 142. In certain embodiments, the OCR confidence score selector component 822 is configured to be the same as or similar to the OCR confidence score selector component 226, 302, and/or 328. In certain embodiments, the rotation angle estimator component 824 is configured to be the same as or similar to the rotation angle estimator component 234, 316, and/or 338. In certain embodiments, the synthetic document generator component 826 is configured to be the same as or similar to the synthetic document generator component 212. In certain embodiments, the document rotator component 828 is configured to be the same as or similar to the document rotator component 216. In certain embodiments, the document rotator component 830 is configured to be the same as or similar to the document rotator component 228. In certain embodiments, the OCR component 832 is configured to be the same as or similar to the OCR component 230, 304, and/or 330. In certain embodiments, the patch extractor and rotator component 834 is configured to be the same as or similar to the patch extractor and rotator component 308. In some embodiments, the patch extractor component 836 is configured to be the same as or similar to the patch extractor component 332 and/or 404.

Note that FIG. 8 is just one example of a processing system consistent with aspects described herein, and other processing systems having additional, alternative, or fewer components are possible consistent with this disclosure.

### Example Clauses

Implementation examples are described in the following numbered clauses:

Clause 1: A method for training a machine learning model for document rotation detection, comprising: rotating each document image in a first set of document images by a plurality of rotation angles to obtain a first set of rotated document images, wherein each document image in the first set of document images has a known orientation; associating a rotation classification label to each rotated document image in the first set of rotated document images; for each document image in a second set of document images: rotating the respective document image by a plurality of rotation angles, performing an optical character recognition analysis at each rotation angle of the plurality of rotation angles, generating a confidence score based on the optical character recognition analyses, assigning the confidence score to the respective document image, and associating a rotation classification to the respective document image based on the optical character recognition analyses; and training a machine learning model to detect document rotation based on a combination of the first set of rotated document images having the associated rotation classification labels and the second set of document images having the confidence scores and the associated rotation classifications.

Clause 2: The method of Clause 1, wherein generating the confidence score based on the optical character recognition analyses comprises: recording an optical character recognition analysis confidence score at each rotation angle of the plurality of rotation angles; and comparing the optical character recognition analysis confidence scores for each rotation angle of the plurality of rotation angles to identify a highest confidence score, wherein the confidence score has the highest confidence score.

Clause 3: The method of any one of Clauses 1-2, wherein the plurality of rotation angles comprise 0, 90, 180, and 270 degrees.

Clause 4: The method of any one of Clauses 1-3, further comprising adding text to one or more portions of an empty document field within a document image to generate the first set of document images.

Clause 5: The method of any one of Clauses 1-4, wherein training the machine learning model on the combination of the first set of rotated document images and the second set of document images comprises iteratively determining a loss using an uncertainty-aware loss function that weights loss terms based on magnitudes of the confidence scores.

Clause 6: The method of any one of Clauses 1-5, further comprising assigning a confidence score to each document image in the first set of rotated document images.

Clause 7: The method of any one of Clauses 1-6, further comprising: using optical character recognition to detect regions of text in the document images; cropping portions of the document images that include one or more detected regions of text to generate one or more text image patches; adding the one or more text image patches to a training dataset; and training the machine learning model on the training dataset comprising the one or more text image patches.

Clause 8: The method of any one of Clauses 1-7, wherein assigning the generated confidence score comprises: analyzing the document image using optical character recognition to detect one or more text regions; extracting one or more cropped image patches that include the detected one or more text regions from the document image; performing an optical character recognition process on the one or more extracted cropped image patches at different rotation angles; and assigning the generated confidence score based on the extracted one or more cropped image patches at different rotation angles.

Clause 9: The method of any one of Clauses 1-8, further comprising: providing a document to the trained machine learning model; determining a document rotation for the provided document; and rotating the provided document to a known rotation based on the determined document rotation.

Clause 10: A method for correcting a rotated document comprising: providing a document image to a machine learning model trained on training data including: a first set of rotated document images, each rotated document image of the first set of rotated document images being associated with a known orientation label, and a second set of document images associated with an estimated orientation label and assigned an uncertainty weighting label based on an optical character recognition process, wherein the optical character recognition process is performed on a rotated version of each document in the second set of document images; determining a document rotation for the provided document image; and rotating the provided document image to a known rotation based on the determined document rotation.

Clause 11: The method of Clause 10, wherein the optical character recognition process is performed on each document in the second set of document images at angles comprising 0, 90, 180, and 270 degrees.

Clause 12: A processing system, comprising: a memory comprising computer-executable instructions; and a processor configured to execute the computer-executable instructions and cause the processing system to perform a method in accordance with any one of Clauses 1-11.

Clause 13: A processing system, comprising means for performing a method in accordance with any one of Clauses 1-11.

Clause 14: A non-transitory computer-readable medium storing program code for causing a processing system to perform the steps of any one of Clauses 1-11.

Clause 15: A computer program product embodied on a computer-readable storage medium comprising code for performing a method in accordance with any one of Clauses 1-11.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for training a machine learning model for document rotation detection, comprising:
rotating each document image in a first set of document images by a plurality of rotation angles to obtain a first set of rotated document images, wherein each document image in the first set of document images has a known orientation;
associating a rotation classification label to each rotated document image in the first set of rotated document images;
for each document image in a second set of document images:
rotating the respective document image by a plurality of rotation angles,
performing an optical character recognition analysis at each rotation angle of the plurality of rotation angles,
generating a confidence score based on the optical character recognition analyses,
assigning the confidence score to the respective document image, and
associating a rotation classification label to the respective document image based on the optical character recognition analyses, the rotation classification label being analogous to the rotation classification labels associated with the first set of rotated document images; and
training a machine learning model to detect document rotation based on a combination of the first set of rotated document images having the associated rotation classification labels and the second set of document images having the confidence scores and the associated rotation classification labels.

2. The method of claim 1, wherein generating the confidence score based on the optical character recognition analyses comprises:
recording an optical character recognition analysis confidence score at each rotation angle of the plurality of rotation angles; and
comparing the optical character recognition analysis confidence scores for each rotation angle of the plurality of rotation angles to identify a highest confidence score, wherein the confidence score has the highest confidence score.

3. The method of claim 2, wherein the plurality of rotation angles comprise 0, 90, 180, and 270 degrees.

4. The method of claim 1, further comprising adding text to one or more portions of an empty document field within a document image to generate the first set of document images.

5. The method of claim 1, wherein training the machine learning model on the combination of the first set of rotated document images and the second set of document images comprises iteratively determining a loss using an uncertainty-aware loss function that weights loss terms based on magnitudes of the confidence scores.

6. The method of claim 5, further comprising assigning a confidence score to each document image in the first set of rotated document images.

7. The method of claim 1, further comprising:
using optical character recognition to detect regions of text in the document images;
cropping portions of the document images that include one or more detected regions of text to generate one or more text image patches;
adding the one or more text image patches to a training dataset; and
training the machine learning model on the training dataset comprising the one or more text image patches.

8. The method of claim 1, wherein assigning the generated confidence score comprises:
analyzing the document image using optical character recognition to detect one or more text regions;
extracting one or more cropped image patches that include the detected one or more text regions from the document image;
performing an optical character recognition process on the one or more extracted cropped image patches at different rotation angles; and
assigning the generated confidence score based on the extracted one or more cropped image patches at different rotation angles.

9. The method of claim 1, further comprising:
providing a document to the trained machine learning model;
predicting a document rotation angle for the provided document; and
rotating the provided document to a known rotation angle based on the predicted document rotation angle.

10. A processing system, comprising:
a memory comprising computer-executable instructions; and
a processor configured to execute the computer-executable instructions and cause the processing system to:
rotate each document image in a first set of document images by a plurality of rotation angles to obtain a first set of rotated document images, wherein each document image in the first set of document images has a known orientation;
associate a rotation classification label to each rotated document image in the first set of rotated document images;
for each document image in a second set of document images:
rotate the respective document image by a plurality of rotation angles,
perform an optical character recognition analysis at each rotation angle of the plurality of rotation angles,
generate a confidence score based on the optical character recognition analyses,
assign the confidence score to the respective document image, and
associate a rotation classification label to the respective document image based on the optical character recognition analyses, the rotation classification label being analogous to the rotation classification labels associated with the first set of rotated document images; and
train a machine learning model to detect document rotation based on a combination of the first set of rotated document images having the associated rotation classifications and the second set of document images having the confidence scores and the associated rotation classifications.

11. The system of claim 10, wherein the instructions further cause the system to:
record an optical character recognition analysis confidence score at each rotation angle of the plurality of rotation angles; and
compare the optical character recognition analysis confidence scores for each rotation angle of the plurality of rotation angles to identify a highest confidence score, wherein the confidence score has the highest confidence score.

12. The system of claim 11, wherein the plurality of rotation angles comprise 0, 90, 180, and 270 degrees.

13. The system of claim 10, wherein the instructions further cause the system to add text to one or more portions of an empty document field within a document image to generate the first set of document images.

14. The system of claim 10, wherein the instructions further cause the system to train the machine learning model by iteratively determining a loss using an uncertainty-aware loss function that weights loss terms based on magnitudes of the confidence scores.

15. The system of claim 14, wherein the instructions further cause the system to assign a confidence score to each document image in the first set of rotated document images.

16. The system of claim 10, wherein the instructions further cause the system to:
use optical character recognition to detect regions of text in the document images;
crop portions of the document images that include one or more detected regions of text to generate one or more text image patches;
add the one or more text image patches to a training dataset; and
train the machine learning model on the training dataset comprising the one or more text image patches.

17. The system of claim 10, wherein the instructions further cause the system to:
analyze the document image using optical character recognition to detect one or more text regions;
extract one or more cropped image patches that include the detected one or more text regions from the document image;
perform an optical character recognition process on the one or more extracted cropped image patches at different rotation angles; and
assign the generated confidence score based on the extracted one or more cropped image patches at different rotation angles.

18. The system of claim 10, wherein the instructions further cause the system to:
provide a document to the trained machine learning model;
predict a document rotation angle for the provided document; and
rotate the provided document to a known rotation angle based on the predicted document rotation angle.

19. A method for correcting a rotated document comprising:
providing a document image to a machine learning model trained on training data including:
a first set of rotated document images, each rotated document image of the first set of rotated document images being associated with a known orientation label, and
a second set of document images associated with an estimated orientation label and assigned an uncertainty weighting label based on an optical character recognition process, wherein the optical character recognition process is performed on a rotated version of each document in the second set of document images;
predicting a document rotation angle for the provided document image; and
rotating the provided document image to a known rotation angle based on the predicted document rotation angle.

20. The method of claim 19, wherein the optical character recognition process is performed on each document in the second set of document images at angles comprising 0, 90, 180, and 270 degrees.
